(19) United States
(12) Patent Application Publication
(10) Pub. No.: US 2010/0157117 A1
(43) Pub. Date: Jun. 24, 2010

(54) VERTICAL STACK OF IMAGE SENSORS WITH CUTOFF COLOR FILTERS

(76) Inventor: Yu Wang, McKinney, TX (US)

Correspondence Address: EASTMAN KODAK COMPANY;PATENT LEGAL STAFF, 343 STATE STREET, ROCHESTER, NY, 14650-2201, US

(21) Appl. No.: 12/611,200

(22) Filed: Nov. 3, 2009

Related U.S. Application Data
(60) Provisional application No. 61/138,701, filed on Dec. 18, 2008.

(51) Int. Cl. H04N 5/335

(52) U.S. Cl. 348/276; 348/E05.091

(57) ABSTRACT

A vertically stacked image sensor includes two or more image sensors aligned vertically one on top of the other. One or more cutoff color filters is positioned between each image sensor. The first image sensor in the stack receives light from a subject scene and each inferior image sensor receives the light that passes through each previous cutoff color filter.

### CROSS REFERENCE TO RELATED APPLICATIONS

This application claims the benefit of U.S. Provisional Application 61/138,701 filed on Dec. 18, 2008, which is hereby incorporated by reference.

### TECHNICAL FIELD

The present invention relates generally to image sensors for use in digital cameras and other types of image capture devices, and more particularly to a vertically stacked image sensor that includes two or more image sensors having one or more cutoff color filters disposed between each image sensor.

### BACKGROUND

A typical electronic image sensor includes a number of light sensitive picture elements (“pixels”) arranged in a two-dimensional array in a sensor layer. The light received by an image sensor propagates at a variety of different wavelengths, with various wavelength ranges being associated with particular colors. For example, light propagating at wavelengths between 400 and 500 nanometers is associated with the color blue, while light propagating at wavelengths between 600 to 700 nanometers is associated with the color red.

Conventional image sensors use a variety of methods to obtain color separation. One such method uses a color filter array (CFA) formed over the pixels in the image sensor. The pattern of the CFA provides each pixel with a color photoresponse exhibiting a predominant sensitivity to one of three designated portions of the visible spectrum. The three designated portions may be, for example, red, green and blue, or cyan, magenta and yellow. One commonly used type of CFA pattern is the Bayer pattern, disclosed in U.S. Pat. No. 3,971,065 and entitled “Color Imaging Array.”

Another method uses the differences in light absorption lengths in silicon for color separation. U.S. Pat. No. 7,453,110 discloses one technique for capturing light based on absorption lengths in silicon. A blue photodiode region is formed at a first depth in a substrate, a green photodiode region at a second deeper depth, and a red photodiode region at a third depth that is deepest within the substrate. In this regard, the incoming light is stored in separate regions of the substrate according to its wavelength.

One limitation to the above-described methods is color cross-talk. Color crosstalk occurs when light propagating at one color wavelength is captured at the incorrect depth in the substrate or is received by a pixel adjacent to the correct pixel. Color crosstalk negatively affects the quality of the images captured by an image sensor.

### SUMMARY

A vertically stacked image sensor includes two or more image sensors aligned vertically one on top of the other. A transparent spacer can be positioned between each image sensor. One or more cutoff color filters (CCF), which only allow photons with wavelengths longer or shorter than a specific or cutoff wavelength to pass through, is also positioned between each image sensor. One example of a CCF is a long pass color filter (LPCF). The first image sensor in the stack receives light from a subject scene and each underlying inferior image sensor receives the light that passes through each previous CCF. Thus, each image sensor receives light propagating at a particular wavelength range.

The one or more CCFs can be disposed on a bottom surface of a superior image sensor or on a top surface of an inferior image sensor. When a CCF is disposed on a bottom surface of a superior image sensor, an anti-reflective layer can be formed over the CCF. When the one or more CCFs is disposed on a top surface of an inferior image sensor, an anti-reflective layer can be formed between the CCF and the top surface of the inferior image sensor.

### ADVANTAGEOUS EFFECT OF THE INVENTION

A vertically stacked image sensor provides good color separation and captures high resolution color images. Additionally, a vertically stacked image sensor can capture images using a single lens, thereby reducing the cost of the image sensor.

### BRIEF DESCRIPTION OF THE DRAWINGS

The above and other objects, features and advantages of the invention will become more apparent by reference to the following detailed description of the invention taken in conjunction with the accompanying drawings, wherein:

FIG. 1 is a simplified block diagram of an image capture device in an embodiment in accordance with the invention;

FIG. 2 is a simplified block diagram of vertically stacked image sensor 106 shown in FIG. 1 in an embodiment in accordance with the invention;

FIG. 3 is a cross section view of an exemplary silicon on insulator (SOI) image sensor structure that can be used for one or more image sensors in vertically stacked image sensor 106 in an embodiment in accordance with the invention;

FIG. 4 is a cross section view of an exemplary bulk semiconductor image sensor structure that can be used for one or more image sensors in vertically stacked image sensor 106 in an embodiment in accordance with the invention;

FIG. 5 is a simplified illustration of a lens and a vertically stacked image sensor in an embodiment in accordance with the invention; and

FIG. 6 is a flowchart depicting a method for fabricating a vertically stacked image sensor in an embodiment in accordance with the invention.

### DETAILED DESCRIPTION

Throughout the specification and claims, the following terms take the meanings explicitly associated herein, unless the context clearly dictates otherwise. The meaning of “a,” “an,” and “the” includes plural reference, the meaning of “in” includes “in” and “on.” The term “connected” means either a direct electrical connection between the items connected or an indirect connection through one or more passive or active intermediary devices. The term “circuit” means either a single component or a multiplicity of components, either active or passive, that are connected together to provide a desired function. The term “signal” means at least one current, voltage, or data signal.

Additionally, directional terms such as “on”, “over”, “top”, “bottom”, are used with reference to the orientation of the Figure(s) being described. Because components of embodiments of the present invention can be positioned in a number of different orientations, the directional terminology is used for purposes of illustration only and is in no way limiting. When used in conjunction with layers of an image sensor wafer or corresponding image sensor, the directional terminology is intended to be construed broadly, and therefore should not be interpreted to preclude the presence of one or more intervening layers or other intervening image sensor features or elements. Thus, a given layer that is described herein as being formed on or formed over another layer may be separated from the latter layer by one or more additional layers.

Referring to the drawings, like numbers indicate like parts throughout the views.

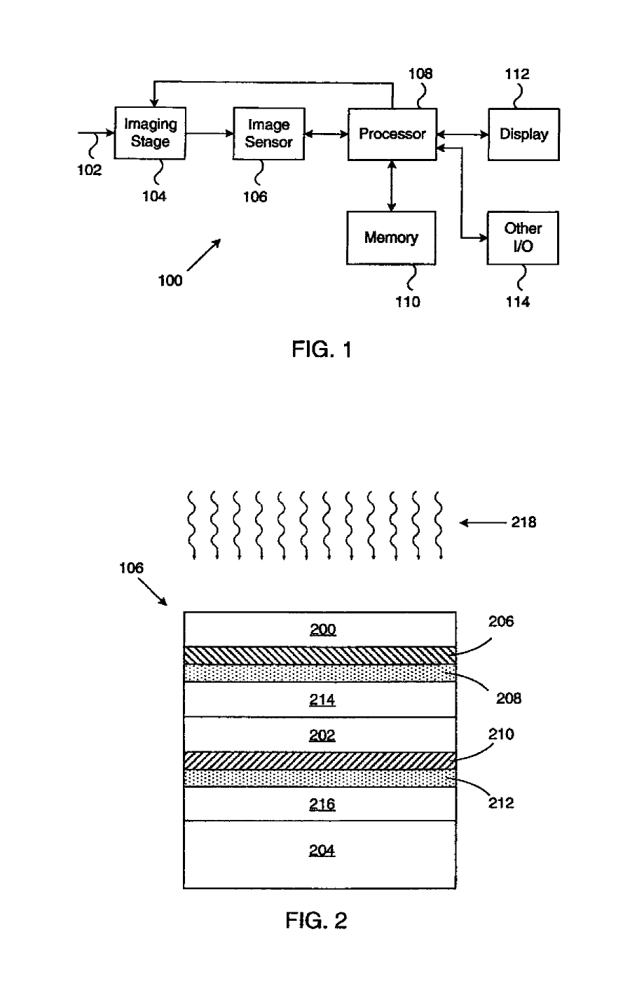

FIG. 1 is a simplified block diagram of an image capture device in an embodiment in accordance with the invention. Image capture device 100 is implemented as a digital camera in FIG. 1. Those skilled in the art will recognize that a digital camera is only one example of an image capture device that can utilize an image sensor incorporating the present invention. Other types of image capture devices, such as, for example, cell phone cameras and digital video camcorders, can be used with the present invention.

In digital camera 100, light 102 from a subject scene is input to an imaging stage 104. Imaging stage 104 can include conventional elements such as a lens, a neutral density filter, an iris and a shutter. Light 102 is focused by imaging stage 104 to form an image on vertically stacked image sensor 106. Vertically stacked image sensor 106 captures one or more images by converting the incident light into electrical signals. Digital camera 100 further includes processor 108, memory 110, display 112, and one or more additional input/output (I/O) elements 114. Although shown as separate elements in the embodiment of FIG. 1, imaging stage 104 may be integrated with vertically stacked image sensor 106, and possibly one or more additional elements of digital camera 100, to form a compact camera module.

Processor 108 may be implemented, for example, as a microprocessor, a central processing unit (CPU), an application-specific integrated circuit (ASIC), a digital signal processor (DSP), or other processing device, or combinations of multiple such devices. Various elements of imaging stage 104 and vertically stacked image sensor 106 may be controlled by timing signals or other signals supplied from processor 108.

Memory 110 may be configured as any type of memory, such as, for example, random access memory (RAM), read-only memory (ROM), Flash memory, disk-based memory, removable memory, or other types of storage elements, in any combination. A given image captured by vertically stacked image sensor 106 may be stored by processor 108 in memory 110 and presented on display 112. Display 112 is typically an active matrix color liquid crystal display (LCD), although other types of displays may be used. The additional I/O elements 114 may include, for example, various on-screen controls, buttons or other user interfaces, network interfaces, or memory card interfaces.

It is to be appreciated that the digital camera shown in FIG. 1 may comprise additional or alternative elements of a type known to those skilled in the art. Elements not specifically shown or described herein may be selected from those known in the art. As noted previously, the present invention may be implemented in a wide variety of image capture devices. Also, certain aspects of the embodiments described herein may be implemented at least in part in the form of software executed by one or more processing elements of an image capture device. Such software can be implemented in a straightforward manner given the teachings provided herein, as will be appreciated by those skilled in the art.

Referring now to FIG. 2, there is shown a simplified block diagram of vertically stacked image sensor 106 in an embodiment in accordance with the invention. Image sensor 106 includes first image sensor 200, second image sensor 202, and third image sensor 204 in the embodiment of FIG. 2. First cutoff color filter (CCF) 206 is disposed on the bottom surface of first image sensor 200, and first anti-reflective layer 208 is formed over first CCF 206. First CCF 206 can be configured as an interference filter or dye color filter in one or more embodiments in accordance with the invention. By way of example only, first CCF 206 is implemented as a long pass color filter (LPCF) having a cut off wavelength of 480 nanometers in an embodiment in accordance with the invention. A yellow color filter is an exemplary LPCF with such a cut off wavelength.

Second CCF 210 is disposed on the bottom surface of second image sensor 202, and second anti-reflective layer 212 is formed over second CCF 210. Second CCF 210 is configured as an interference filter or dye color filter in an embodiment in accordance with the invention. By way of example only, second CCF 210 is implemented as another LPCF having a cut off wavelength of 580 nanometers in an embodiment in accordance with the invention. A red color filter is an exemplary color filter with such a cut off wavelength.

Transparent spacer 214 is positioned between first anti-reflective layer 208 and second image sensor 202. Another transparent spacer 216 is positioned between second anti-reflective layer 212 and third image sensor 204. Transparent spacers 214, 216 are implemented as transparent optical glue or plastic spacers in an embodiment in accordance with the invention. The thickness of the transparent spacers 214, 216 is determined by the optical requirements of an image capture device.

When light 218 strikes first image sensor 200, first CCF 206 blocks some of the light from passing onto second image sensor 202. When first CCF 206 is configured as a LPCF, first CCF 206 blocks light propagating at wavelengths shorter than the cutoff wavelength while light having wavelengths longer than the cutoff wavelength pass onto second image sensor 202. By way of example only, when first color filter 206 is a yellow filter, first color filter 206 absorbs the blue light while red and green light pass through to strike second image sensor 202.

Second CCF 210 then blocks some of the light from passing onto third image sensor 204. When second CCF 210 is a LPCF, second CCF 210 blocks light propagating at wavelengths shorter than its cutoff wavelength while passing light at wavelengths longer than the cutoff wavelength onto third image sensor 204. For example, when second cutoff color filter 210 is a red filter, second cutoff color filter 210 absorbs the green light while red light passes through to strike third image sensor 204. This allows third image sensor 204 to sense substantially only red light.

First, second, and third image sensors 200, 202, 204 can each be implemented as any type of image sensor. For example, the image sensors can be Complementary Metal Oxide Semiconductor (CMOS) or Charge Couple Device (CCD) image sensors. The image sensors can be front-illuminated or back-illuminated image sensors. And finally, the image sensors can be fabricated with any type of wafer or substrate, including, but not limited to, silicon, silicon-on-insulator (SOI) technology, silicon-on-sapphire (SOS) technology, doped and undoped semiconductors, epitaxial layers formed on a semiconductor substrate, and other semiconductor structures.

Vertically stacked image sensor 106 is shown in FIG. 2 with three image sensors. Other embodiments in accordance with the invention are not limited to this number of image sensors. A vertically stacked image sensor can be fabricated with two or more image sensors. For example, in another embodiment in accordance with the invention, first and second image sensors 200, 202 are attached together with a cutoff color filter disposed between the two image sensors. First image sensor 200 receives light from a subject scene while second image sensor 202 receives only infrared light. An anti-reflective layer and a transparent spacer may also be positioned between the two image sensors.

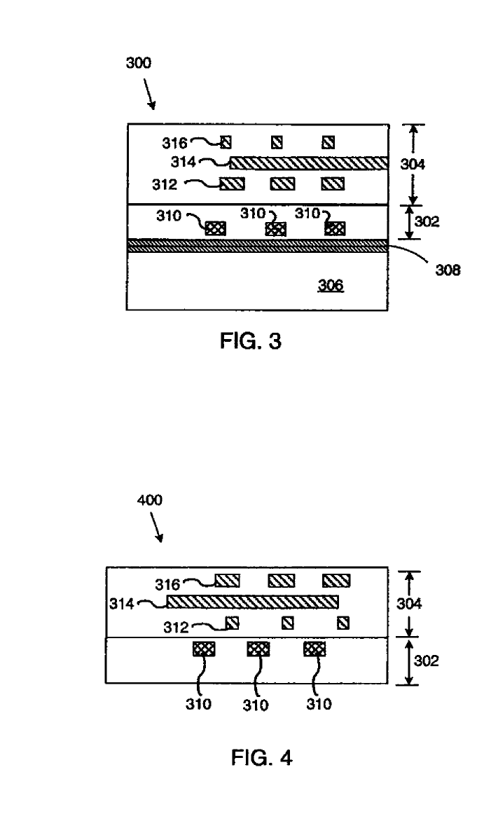

FIG. 3 is a cross section view of an exemplary silicon on insulator (SOI) image sensor structure that can be used for one or more image sensors in vertically stacked image sensor 106 in an embodiment in accordance with the invention. For example, in one embodiment in accordance with the invention, first and second image sensors 200, 202 in FIG. 2 are SOT image sensors.

SOT image sensor 300 includes sensor layer 302, circuit layer 304, and support substrate 306. Sensor layer 302 is formed with a semiconductor material, circuit layer 304 with an insulating material, and support substrate 306 with a transparent material, such as glass, in an embodiment in accordance with the invention. With SOT image sensors, an insulating layer 308 is disposed between sensor layer 302 and support substrate 306. Insulating layer 308 is typically a layer of silicon dioxide or silicon nitride. When first and second image sensors 200, 202 are implemented as SOT image sensors, sensor layer 302 in first image sensor 200 has a thickness of approximately 200 nanometers and sensor layer 302 in second image sensor 202 a thickness of 700 nanometers in one embodiment in accordance with the invention.

A number of photosensitive sites 310 and other known elements are formed in sensor layer 302. Only three photosensitive sites 310 are shown in FIG. 3 for the sake of simplicity. Those skilled in the art appreciate an image sensor typically includes thousands or millions of photosensitive sites.

Each photosensitive site 310 converts incident light into an electrical charge or signal. Examples of some of the other known elements that can be formed in sensor layer 302 include charge to voltage conversion mechanisms, such as floating diffusions, buried layers, and doped regions such as source/drain regions.

Circuit layer 304 includes conductive interconnects 312, 314, 316 and other features that connect electrically to photosensitive sites 310 in sensor layer 302. Conductive interconnects 312, 314, 316 include gates and connectors and are typically associated with inter-level metallization layers. Only three inter-level metallization layers are shown in FIG. 3 for the sake of simplicity.

Referring now to FIG. 4, there is shown a cross section view of an exemplary bulk semiconductor image sensor structure that can be used for one or more image sensors in vertically stacked image sensor 106 in an embodiment in accordance with the invention. For example, in one embodiment in accordance with the invention, third image sensor 204 in FIG. 2 is a bulk image sensor.

Image sensor 400 includes sensor layer 302 and circuit layer 304. A number of photosensitive sites 310 and other known elements are formed in sensor layer 302. Only three photosensitive sites 310 are shown in FIG. 4 for the sake of simplicity.

Circuit layer 304 includes conductive interconnects 312, 314, 316 and other features that connect electrically to photosensitive sites 310 in sensor layer 302. Again, only three conductive interconnects are shown in FIG. 4 for the sake of simplicity.

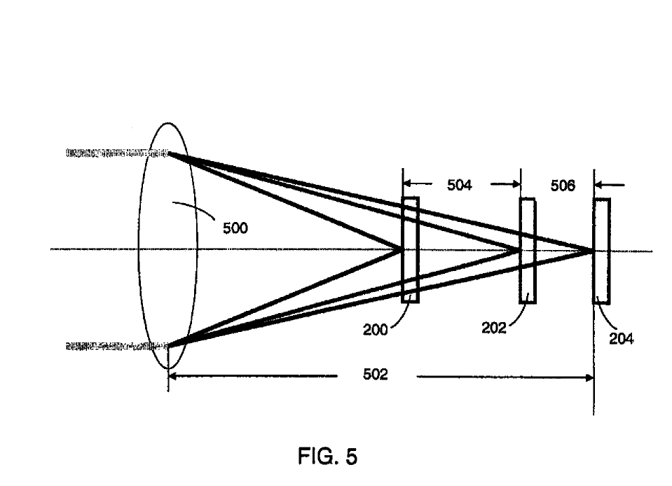

FIG. 5 is a simplified illustration of a lens and a vertically stacked image sensor in an embodiment in accordance with the invention. Instead of using achromatic lenses that are used with conventional image sensors, a single lens 500 can be used with a vertically stacked image sensor to acquire images. Either mechanical alignment or electronic alignment can be used for the pixels. In one embodiment in accordance with the invention, the distance 502 between lens 500 and third image sensor 204 is 30 millimeters, the distance 504 between first image sensor 200 and second image sensor 202 is 250 micrometers, and the distance 506 between second image sensor 202 and third image sensor 204 is 150 micrometers.

Those skilled in the art will recognize these distances can vary from embodiment to embodiment.

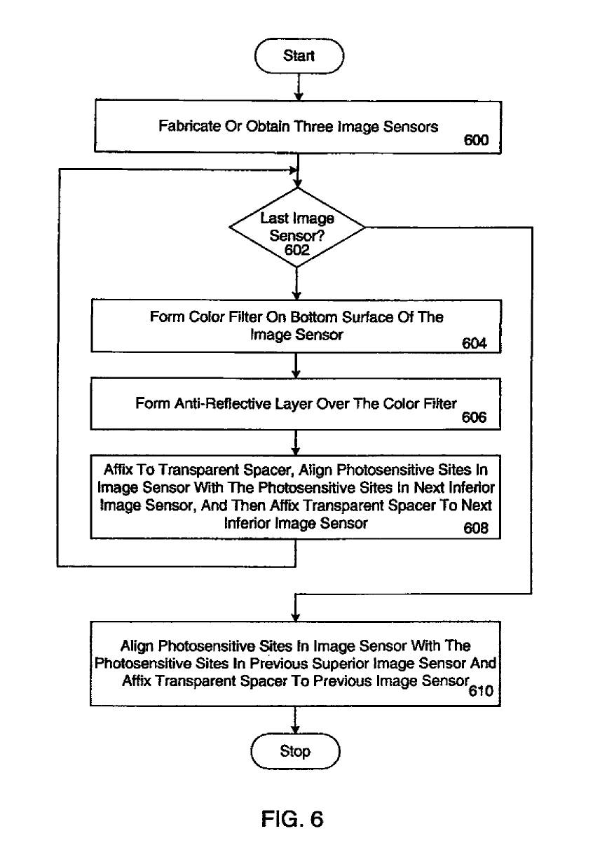

Referring now to FIG. 6, there is shown a flowchart of a method for constructing a vertically stacked image sensor in an embodiment in accordance with the invention. Initially, the image sensors to be included in the vertically stacked image sensor are fabricated or obtained (block 600). A determination is then made as to whether or not the image sensor currently being processed is the last image sensor in the vertical stack (block 602). If not, the process passes to block 604 where one or more cutoff color filters is formed on the bottom surface of the image sensor.

Next, at block 606, an anti-reflective layer is formed on the cutoff color filter. A transparent spacer is affixed to the anti-reflective layer, the photosensitive sites in the image sensor are aligned with the next image sensor, and the transparent spacer is affixed to the next inferior image sensor (block 608). The method then returns to block 602 and repeats until the image sensor is the last image sensor in the vertically stacked image sensor. At that point, the process passes to block 610 where the photosensitive sites in the previous superior image sensor are aligned with the photosensitive sites in the last image sensor. The transparent spacer is then affixed to the last image sensor.

The invention has been described with reference to specific embodiments of the invention. However, it will be appreciated that a person of ordinary skill in the art can effect variations and modifications without departing from the scope of the invention. Additionally, even though specific embodiments of the invention have been described herein, it should be noted that the application is not limited to these embodiments. In particular, any features described with respect to one embodiment may also be used in other embodiments, where compatible. And the features of the different embodiments may be exchanged, where compatible.

By way of example only, the present invention is described as having the cutoff color filter formed on a bottom surface of a superior image sensor and an anti-reflective layer formed over the cutoff color filter. Other embodiments in accordance with the invention can form the anti-reflective layer on a top surface of an inferior image sensor and one or more cutoff color filters over the anti-reflective layer. In these embodiments, the transparent spacer is disposed between the bottom surface of the previous superior image sensor and the cutoff color filter layer on the top surface of the next inferior image sensor.

A vertically stacked image sensor can include a first image sensor that receives light from a subject scene and a second image sensor inferior to and attached to the first image sensor. A cutoff color filter having a first cutoff wavelength can be disposed between the first image sensor and the second image sensor that, based on the first cutoff wavelength, allows only a portion of the light received by the first image sensor to be received by the second image sensor. The portion of the light received by the second image sensor can be only infrared light. The first cutoff color filter can be disposed on a surface of the first image sensor. The first cutoff color filter can be disposed on a surface of the second image sensor.

An anti-reflective layer can be disposed between the first cutoff color filter and the second image sensor. A first transparent spacer can be positioned between the anti-reflective layer and the second image sensor.

A second cutoff color filter having a second cutoff wavelength different from the first cutoff wavelength can be disposed between the second image sensor and a third image sensor. Based on the second cutoff wavelength, the second cutoff color filter allows only a portion of the light received by the second image sensor to be received by the third image sensor. The second cutoff color filter can be disposed on a bottom surface of the second image sensor. An anti-reflective layer can be disposed between the second color filter and the third image sensor. A second transparent spacer can be positioned between the anti-reflective layer and the third image sensor.

A method for fabricating a vertically stacked image sensor can include positioning a first cutoff color filter having a first cutoff wavelength between a first image sensor that receives light from a subject scene and a second image sensor inferior to the first image sensor. Based on the first cutoff wavelength of the first cutoff color filter, the second image sensor receives only a portion of the light received by the first image sensor. The first cutoff color filter can be positioned on a surface of the first image sensor. The first cutoff color filter can be positioned on a surface of the second image sensor.

The second image sensor is attached to the first image sensor.

A second cutoff color filter having a second cutoff wavelength different from the first cutoff wavelength can be positioned between the second image sensor and a third image sensor inferior to the second image sensor. Based on the second cutoff wavelength, the third image sensor receives only a portion of the light received by the second image sensor. The second cutoff color filter can be positioned on a surface of the second image sensor. The second cutoff color filter can be positioned on a surface of the third image sensor.

The third image sensor can be attached to the second image sensor.

Prior to attaching the second image sensor to the first image sensor, a plurality of photosensitive sites in the second image sensor can be aligned with a plurality of photosensitive sites in the first image sensor.

Prior to attaching the second image sensor to the first image sensor, a transparent spacer can be positioned between the first and second image sensors.

Prior to attaching the third image sensor to the second image sensor, a plurality of photosensitive sites in the third image sensor can be aligned with a plurality of photosensitive sites in the second image sensor.

Prior to attaching the third image sensor to the second image sensor, a transparent spacer can be positioned between the third and second image sensors.

### PARTS LIST

100 image capture device
102 light
104 imaging stage
106 vertically stacked image sensor
108 processor
110 memory
112 display
114 other input/output (I/O) elements
200 first image sensor
202 second image sensor
204 third image sensor
206 first cutoff color filter (CCF)
208 anti-reflective layer
210 second CCF
212 anti-reflective layer
214 transparent spacer
216 transparent spacer
218 light
300 SOI image sensor
302 sensor layer
304 circuit layer
306 support substrate
308 insulating layer
310 photosensitive sites
312 conductive interconnect
314 conductive interconnect
316 conductive interconnect
400 bulk semiconductor image sensor
500 lens
502 distance
504 distance
506 distance

1. A vertically stacked image sensor, comprising:
a first image sensor that receives light from a subject scene;
a second image sensor inferior to and attached to the first image sensor; and
a cutoff color filter having a first cutoff wavelength disposed between the first image sensor and the second image sensor that, based on the first cutoff wavelength, allows only a portion of the light received by the first image sensor to be received by the second image sensor.

2. The vertically stacked image sensor of claim 1, further comprising:
a third image sensor inferior to and attached to the second image sensor; and
a second cutoff color filter having a second cutoff wavelength different from the first cutoff wavelength disposed between the second image sensor and the third image sensor that, based on the second cutoff wavelength, the second cutoff color filter allows only a portion of the light received by the second image sensor to be received by the third image sensor.

3. The vertically stacked image sensor of claim 1, wherein the first cutoff color filter is disposed on a bottom surface of the first image sensor.

4. The vertically stacked image sensor of claim 1, wherein at least one of the first and second cutoff color filters comprises a long pass color filter.

5. The vertically stacked image sensor of claim 3, further comprising an anti-reflective layer disposed between the first cutoff color filter and the second image sensor.

6. The vertically stacked image sensor of claim 5, further comprising a first transparent spacer positioned between the anti-reflective layer and the second image sensor.

7. The vertically stacked image sensor of claim 2, wherein the second cutoff color filter is disposed on a bottom surface of the second image sensor.

8. The vertically stacked image sensor of claim 7, further comprising an anti-reflective layer disposed between the second color filter and the third image sensor.

9. The vertically stacked image sensor of claim 8, further comprising a second transparent spacer positioned between the anti-reflective layer and the third image sensor.

10. A vertically stacked image sensor, comprising:
a first image sensor that receives light from a subject scene;
a second image sensor inferior to and attached to the first image sensor; and
a cutoff color filter having a first cutoff wavelength disposed between the first and second image sensors that, based on the first cutoff wavelength, allows only infrared light to be received by the second image sensor.

11. A method for fabricating a vertically stacked image sensor, the method comprising:
positioning a first cutoff color filter having a first cutoff wavelength between a first image sensor that receives light from a subject scene and a second image sensor inferior to the first image sensor that, based on the first cutoff wavelength of the first cutoff color filter, receives only a portion of the light received by the first image sensor,
attaching the second image sensor to the first image sensor;
positioning a second cutoff color filter having a second cutoff wavelength different from the first cutoff wavelength between the second image sensor and a third image sensor inferior to the second image sensor that, based on the second cutoff wavelength, receives only a portion of the light received by the second image sensor; and
attaching the third image sensor to the second image sensor.

12. The method of claim 11, further comprising prior to attaching the second image sensor to the first image sensor, aligning a plurality of photosensitive sites in the second image sensor with a plurality of photosensitive sites in the first image sensor prior to attaching the first image sensor to the second image sensor.

13. The method of claim 11, further comprising prior to attaching the second image sensor to the first image sensor, positioning a transparent spacer between the first and second image sensors.

14. The method of claim 11, further comprising prior to attaching the third image sensor to the second image sensor, aligning a plurality of photosensitive sites in the third image sensor with a plurality of photosensitive sites in the second image sensor prior to attaching the third image sensor to the second image sensor.

15. The method of claim 11, further comprising prior to attaching the third image sensor to the second image sensor, positioning a transparent spacer between the third and second image sensors.
